(19) United States
(12) Patent Application Publication
(10) Pub. No.: US 2009/0199044 A1
(43) Pub. Date: Aug. 6, 2009

(54) Device self-maintenance

(76) Inventor: Nicholas J. Hurrell, Dundee (GB)

Correspondence Address: MICHAEL CHAN;NCR CORPORATION, 1700 SOUTH PATTERSON BLVD, DAYTON, OH, 45479-0001, US

(21) Appl. No.: 12/012,164

(22) Filed: Jan. 31, 2008

(51) Int. Cl. G06F 11/07

(52) U.S. Cl. 714/23; 714/E11.021

(57) ABSTRACT

Software running on a processor is operable to control the cycled powering down and powering up of components of a self-service terminal (SST) in order to attempt to rectify a fault within the SST without the need to power down the SST core processor. The software can also control the resetting of universal serial bus (USB) ports associated with the components of the SST in order to try and clear faults associated with a communications link between a component and the SST core processor.

### FIELD OF THE INVENTION

This invention relates to a device self-maintenance method, unit and software. More particularly, but not exclusively it relates to a device self-maintenance method, unit and software for use with a self-service terminal (SST).

### BACKGROUND OF THE INVENTION

Common examples of SSTs include automated teller machines (ATMs), information kiosks, financial services centers, bill payment kiosks, lottery kiosks, postal services machines, check-in and check-out terminals such as those used in the hotel, car rental, and airline industries, retail self-checkout terminals, vending machines, and the like.

Many types of SSTs, such as ATMs and postal services machines, have a number of peripherals that interact to provide a transaction or service, and that dispense media (such as banknotes and receipts) to a user.

Currently, when there is a fault with a SST that prevents the SST from operating, or reduces the capacity of the SST to perform its function, a customer engineer (CE) is dispatched to the site in order to perform a maintenance operation on the SST. This is inefficient, time consuming, and also detrimental to the environment as the CE must travel to the faulty SST.

Typically, the maintenance requires the powering down of the SST, possibly as many as three times during the correction of a single fault. Normally, each power down and power up cycle takes approximately 20 to 30 minutes. The length of these power cycles adds appreciably to the downtime of the SST associated with the fault. Increased downtime results in an increased number of unserved customers and potential customer complaints. Furthermore, the increase in the CE's time spent rectifying the fault due to the length of the power cycles reduces the efficiency of the CE and prevents them from moving on to another SST quickly.

As used herein, a maintenance operation comprises a task or a series of tasks to maintain a SST in, or to return a self-service terminal to, full normal operation, or to a condition where the SST can operate satisfactorily for a customer. A maintenance operation includes servicing the self-service terminal or a part thereof (such as a device installed in the self-service terminal).

### SUMMARY OF THE INVENTION

According to a first aspect of the present invention there is provided a method of device self-maintenance comprising the steps of:

i) receiving at a processor a notification that a component of a device is faulty; and

ii) resetting, in response to an instruction issued by the processor, a respective utility associated with components of the device, cyclically to each of at least some of the components of the device.

The cyclical resetting of a utility associated with component peripherals of the device means that the central processing core of the device need not be shut down. This reduces the start-up time associated with such an operation. The automated nature of the process reduces the number of times that a CW will have to attend a failed device.

The respective utility may comprise power supplied to each of the at least some components of the device.

The re-powering of individual peripheral devices results in the central processing core of the not having to be shut down.

The respective utility may comprise a communications link between each of the at least some components of the device and a core processing unit. The respective utility may comprise a universal serial bus (USB) port.

The method may comprise connecting the device and the processor via a network. Alternatively, the method may comprise operating the processor within the device.

The provision of either on site or off site diagnosis and self-maintenance functionality increases the flexibility of the system by allowing customer engineers to use the functionality when they are at a faulty device.

The method may comprise logging of a disconnection event associated with the cyclical resetting of the utility of each of the at least some components of the device. The method may comprise logging a reconnection event associated with whichever of the at least some components of the device reconnect following the cyclical resetting of the utility.

The method may comprise generating a report comprising details of which of the at least some components of the device exhibited at least one of the following states following the cyclical resetting of the utility: did not reconnect, reconnected, discovered.

The logging and reporting of problems with connection and disconnection of component peripherals allows further diagnosis of faults by a CE which can aid in determining whether a CE needs to be dispatched to deal with a fault.

The device may comprise a self-service terminal. The self-service terminal may comprise an automatic teller machine (ATM), a check-in/check-out terminal, a medical record entry terminal.

According to a second aspect of the present invention there is provided a device self-maintenance unit comprising a processor arranged to receive a notification that a component of a device is faulty and being further arranged to control the resetting of a respective utility associated with components of the device, cyclically to each of at least some of the components of the device.

The respective utility may comprise power supplied to each of the at least some components of the device.

The respective utility may comprise a communications link between each of the at least some components of the device and a core processing unit. The respective utility may comprise a universal serial bus (USB) port.

The device may be arranged to connect to the processor via a network. Alternatively, the device may comprise the processor.

The processor may be arranged to log a disconnection event associated with the cyclical resetting of the utility of each of the at least some components of the device. The processor may be arranged to log a reconnection event associated with whichever of the at least some components of the device reconnect following the cyclical resetting of the utility.

The processor may be arranged to generate a report comprising details of which of the at least some components of the device exhibited at least one of the following states following the cyclical resetting of the utility: did not reconnect, reconnected, discovered.

The device may comprise a self-service terminal. The self-service terminal may comprise an automatic teller machine (ATM), a check-in/check-out terminal, a medical record entry terminal.

According to a third aspect of the present invention there is provided a self-service terminal comprising a device self-maintenance unit according to the second aspect of the present invention.

According to a fourth aspect of the present invention there is provided software, which when executed upon a processor, causes the processor to receive a notification that a component of a device is faulty and control the resetting of a respective utility associated with components of the device, cyclically to each of at least some of the components of the device.

The respective utility controlled by the processor, under the influence of the software, may comprise power supplied to each of the at least some components of the device.

The respective utility controlled by the processor, under the influence of the software, may comprise a communications link between each of the at least some components of the device and a core processing unit. The respective utility controlled by the processor, under the influence of the software, may comprise a universal serial bus (USB) port.

The software, when executed on the processor, may be arranged to connect to the device to the processor via a network. Alternatively, the processor may be located within the device.

The software, when executed on the processor, may be arranged to log a disconnection event associated with the cyclical resetting of the utility of each of the at least some components of the device. The software, when executed on the processor, may be arranged to log a reconnection event associated with whichever of the at least some components of the device reconnect following the cyclical resetting of the utility.

The software, when executed on the processor, may be arranged to generate a report comprising details of which of the at least some components of the device exhibited at least one of the following states following the cyclical resetting of the utility: did not reconnect, reconnected, discovered.

The software may be arranged to be installed on a self-service terminal. The self-service terminal may comprise an automatic teller machine (ATM), a check-in/check-out terminal, a medical record entry terminal.

According to a fifth aspect of the present invention there is provided a data carrier comprising a readable medium tangibly embodying the software of the fourth aspect of the present invention.

According to a sixth aspect of the present invention there is provided software, which when executed on a processor, causes the processor to execute the method of the first aspect of the present invention.

According to a seventh aspect of the present invention there is provided software, which when executed on a processor, causes the processor to act as the processor of device self-maintenance unit of the second aspect of the present invention.

According to a eighth aspect of the present invention there is provided a method of reducing downtime of a SST due to a fault comprising maintaining a SST in accordance with the first aspect of the present invention, or installing a unit according to the second aspect of the present invention into the SST, or placing the SST in operative communication with a unit according to the second aspect of the present invention, or installing software according to the third aspect of the present invention on a processor of the SST.

According to a ninth aspect of the present invention there is provided a method of improving the efficiency of servicing of a SST comprising maintaining a SST in accordance with the first aspect of the present invention, or installing a unit according to the second aspect of the present invention into the SST, or placing the SST in operative communication with a unit according to the second aspect of the present invention, or installing software according to the third aspect of the present invention on a processor of the SST.

According to tenth aspect of the present invention there is a method of increasing customer satisfaction comprising maintaining a SST in accordance with the first aspect of the present invention, or installing a unit according to the second aspect of the present invention into the SST, or placing the SST in operative communication with a unit according to the second aspect of the present invention, or installing software according to the third aspect of the present invention on a processor of the SST.

### BRIEF DESCRIPTION OF THE DRAWINGS

The invention will now be described, by way of example only, with reference to the accompanying drawings, in which:

FIG. 1 is a front elevation of an embodiment of an SST connected to a device self-maintenance unit according to an aspect of the present invention via a network;

FIG. 2 is a schematic view of the internal components of the SST of FIG. 1;

FIG. 3 is a schematic view of the internal components of an embodiment of an SST comprising a device self-maintenance unit according to an aspect of the present invention; and

FIG. 4 is a flow-chart detailing the steps of a method of device self-management according to an aspect of the present invention.

### DETAILED DESCRIPTION OF EXEMPLARY EMBODIMENTS OF THE INVENTION

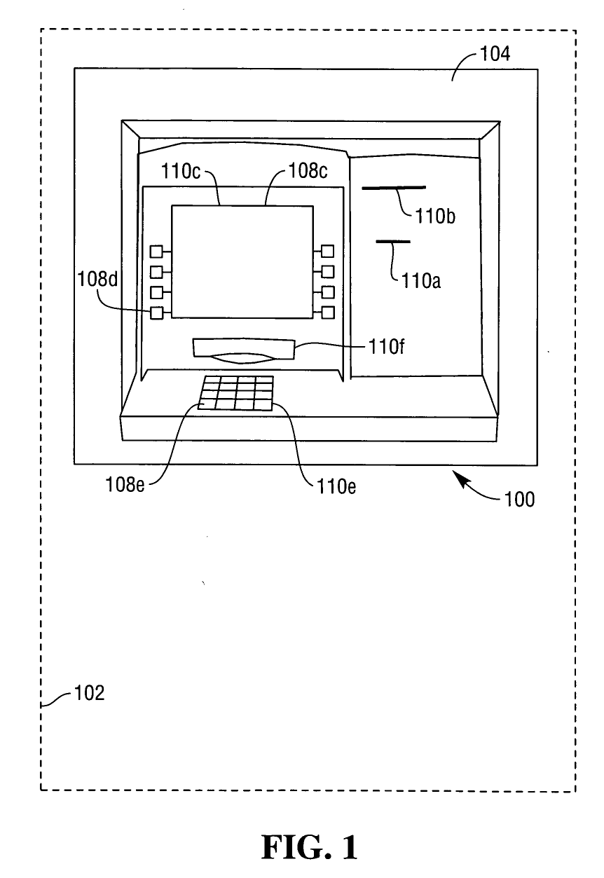

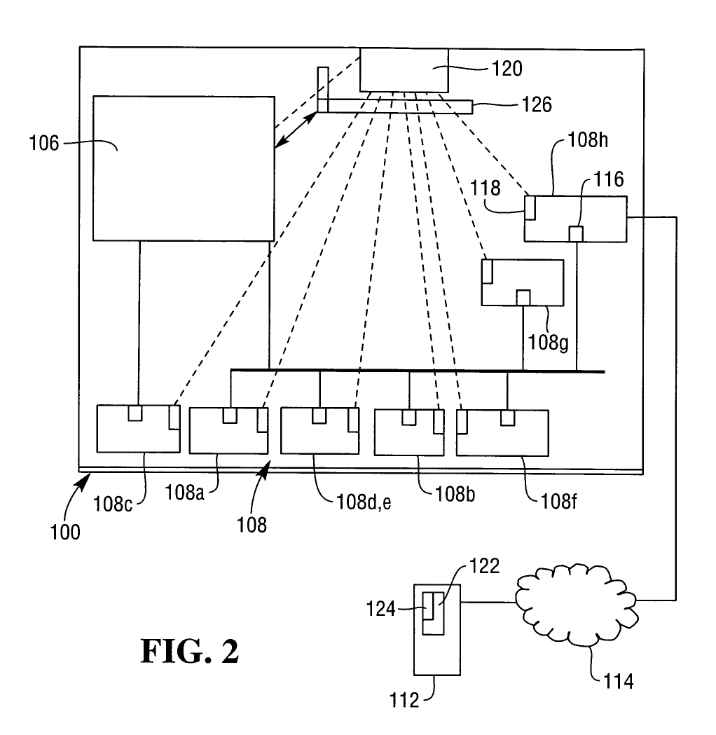

Referring now to FIGS. 1 and 2, a self-service terminal 100 comprises a chassis 102, a plastic fascia 104, a core processing unit 106 and peripheral devices 108.

The fascia 104 has apertures 110 that align with some of the peripheral devices 108 when the fascia 104 is closed. In particular, the fascia 104 defines a card reader slot 110a aligned with a card reader device 108a; a receipt printer slot 110b aligned with a receipt printer device 108b; a display aperture 110c aligning with a display 108c and associated function display keys (FDKs) 108d; a keypad aperture 110e through which an encrypting keypad device 108e protrudes; and a dispenser slot 110f aligned with a dispenser device 108f.

A number of the peripheral devices 108 reside internally of the ATM 100. These devices 108 include: a journal printer device 108g for creating a record of transactions executed by the ATM 10, a network connection device 108h for accessing a remote server 112 via a network 114. Typically, the network 114 is a private network or a virtual private network.

Typically, the core processing unit 106 is a PC processing core operating under, for example, Microsoft Windows XP™ operating system. The core processing unit 106 controls the operation of the ATM 100, including the operation of the peripheral devices 108.

Each of the peripheral devices 108 connects to the core processing unit 106 via input/output (IO) ports 116 at each of the peripheral devices 108. Complimentary IO ports at the core processing unit 106 are not shown for clarity. Typically, the IO ports 116 are USB ports.

Each peripheral device 108 has an individual power supply 118 associated with it. Typically, these power supplies 118 are derived from a common input power supply 120 that also supplies power to the core processing unit 106.

In the present embodiment, the remote server 112 comprises a device self-maintenance unit 121 comprising a processor 122 that runs device self-maintenance software 124. It will be appreciated that although reference is made only to the ATM 100 being connected to the remote serve 112 it is envisaged that a connection will exist between the ATM 100 and a remote authorization server for authorizing customer transactions executed at the ATM.

In the event of a fault occurring with a peripheral device 108 of the ATM 100 that restricts the ability of the ATM 100 to service customer requests notification of this status is sent to the server 112 via the network 114. Non-exhaustive, and non-limiting examples of such faults include when firmware of a peripheral device 108 is not communicating with the core processing unit 106, i.e. the peripheral device 108 is hung, and where a peripheral device 108 is in an indeterminate state and cannot be controlled.

The software 124 running on the processor 122 of the server 112 can attempt to remedy the faulty device automatically without human intervention, or there is the option to request input from a CE. Typically, this is an option set in the software by the CE or other controlling party.

If the software 124 is set in automatic mode it instructs the processor 122 attempts to remedy the fault by controlling the removal and re-application of a utility to each of the peripheral devices 108.

Power may be removed and re-applied to each of the peripheral devices 108 sequentially. The re-powering of the peripheral devices 108 resets their internal processors and control mechanisms and thereby clears many faults.

For example, the journal printer 108g may be powered up and powered down, followed by the display 108c etc. The processor 124 can control the powering up and down of the peripheral devices 108 in a number of ways. Typically, the processor 122 issues an instruction to a control unit 126 that controls switches that temporarily interrupt the power supplied to the peripheral devices' power supplies 118. In an alternative embodiment (not shown), the power supplied by the peripheral devices' power supplies 118 can be interrupted, as the processor 122 controls switches located within the peripheral devices 108 that perform the temporary interruption of this part of the power supply chain.

In cyclically, sequentially, removing and restoring power to the peripheral devices 108 the software 124 logs which peripheral devices 108 are currently connected to the ATM 100. The processor 122 then instructs the removal of power from each peripheral device 108 in turn and the software 124 logs the “device disconnected” plug and play event for as each peripheral device 108 is powered down. Once all the peripheral devices 108 are logged as “disconnected”, the processor 122 issues an instruction to restore power to each of the peripheral devices 108 in sequence. The software 124 logs a “device connected” plug and play event for each peripheral device 108 that reconnects successfully. The software 124 generates a report of those devices that have been re-discovered, newly discovered or lost during the cyclical powering of the peripheral devices.

It is envisaged that the above procedure can be applied to the physical replacement of a device by a CE on-site at a faulty ATM 100. This involves the software 124 issuing a message to the CE, for example via SMS, E-mail or on the screen of the ATM, to physically power down the peripheral device 108 of interest via a physical switch, replace peripheral device 108 of interest and re-power it. The software 124 logs the plug and play “device disconnected” and “device connected” events for each peripheral device to which this procedure is applied and generates a report as detailed above. Such an arrangement removes the requirement for a full system re-start in order to replace a peripheral device 108.

Alternatively, or additionally, the software 124 can cause the processor 122 to reset each of the IO ports 116 associated with each of the peripheral devices 108 can be reset. The resetting of the peripheral devices' IO ports 116 resets the peripheral devices' communications link with the core processing unit 106. Typically, the communications IO ports 116 are reset by an application call, such as that provided in the Microsoft Windows™ operating system.

In cyclically, sequentially, resetting the peripheral devices' IO ports 116 the software 124 logs which peripheral devices 108 are currently connected to the ATM 100. The processor 122 issues a reset command to each peripheral devices IO ports 116 in turn and the software 124 logs the “device disconnected” plug and play event for as each peripheral device 108 loses its communications link to the core processor 106. The software 124 logs a “device connected” plug and play event for each peripheral device 108 that reconnects successfully as their respective communications links with the core processor 106 are re-established following the resetting of the IO ports 116. The software 124 generates a report of those devices that have been re-discovered, newly discovered or lost during the reset of the peripheral devices IO ports 116.

It will be appreciated that either the cyclical re-powering of peripheral devices or the resetting of their IO ports may be carried out individually, or in any order. Consequently, the present invention is not limited to the order of events described herein.

It will be further appreciated that the re-powering of peripheral devices may be carried out independently of the resetting of the IO ports of peripheral devices and vice versa. Furthermore, if both the re-powering of peripheral devices and the resetting of the IO ports of peripheral devices are carried out either of these operations may be carried out first.

It is envisaged that the software 124 may be provided in the form of an application program interface (API) for use by an application in order to allow the application to recover a peripheral device 108 in the manner noted above. Once recovery of the peripheral device 108 has been attempted the API hands control of the peripheral device 108 back to the application.

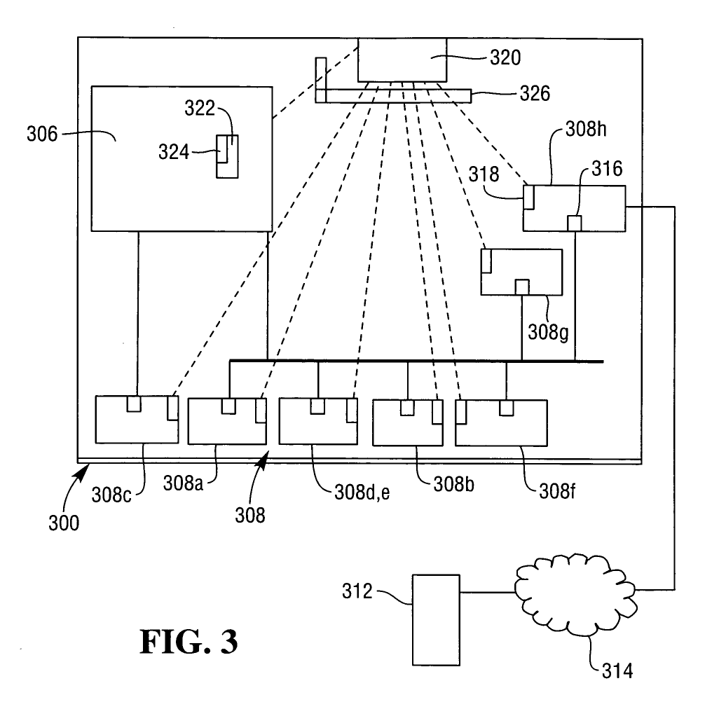

Referring now to FIG. 3, an ATM 300 is substantially similar to that described with reference to FIGS. 1 and 2. Accordingly, the same parts are accorded the same reference numerals in the three-hundred series.

In the present embodiment, the device self-maintenance unit 321 is located within the ATM 300. Accordingly, the operation of the self-maintenance unit 321 does not require the transfer of data across the network 314. In the present embodiment the network connection device 308h is used for transferring authorization data between the ATM 300 and the server 312, which is an authorization server.

The present embodiment operates in substantially in the same manner as that described with reference to FIGS. 1 and 2 except for the differences noted hereinbefore.

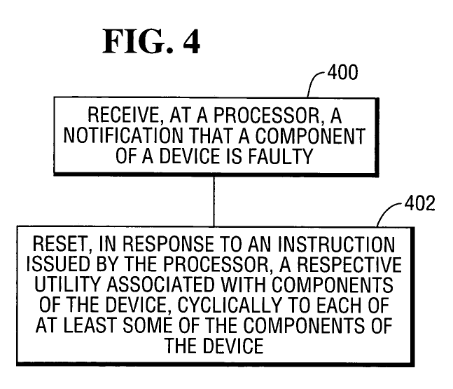

Referring now to FIG. 4, in a method of device self-maintenance a processor receives a notification that a component of a device is faulty (Step 400). A utility associated with components of the device is reset cyclically, in response to an instruction issued by the processor, to each of at least some of the components of the device (Step 402).

It will be appreciated that although described with reference to an ATMs the present invention can be applied to any suitable self-service terminals, for example medical record entry terminals or self-check in/out terminals.

Various modifications may be made to the above described embodiment within the scope of the invention without departing from the spirit of the invention.

1. A method of device self-maintenance comprising the steps of:
i) receiving at a processor a notification that a component of a device is faulty; and
ii) resetting, in response to an instruction issued by the processor, a respective utility associated with components of the device, cyclically to each of at least some of the components of the device.

2. The method of claim 1, wherein the respective utility comprises power supplied to each of the at least some components of the device.

3. The method of claim 1, wherein the respective utility comprises a communications link between each of the at least some components of the device and a core processing unit.

4. The method of claim 3, wherein the communications link comprises a universal serial bus (USB) port.

5. The method of claim 1 comprising logging of a disconnection event associated with the cyclical resetting of the utility of each of the at least some components of the device.

6. The method of claim 1 comprising logging a reconnection event associated with whichever of the at least some components of the device reconnect following the cyclical resetting of the utility.

7. The method of claim 1 comprising generating a report comprising details of which of the at least some components of the device exhibited at least one of the following states following the cyclical resetting of the utility: did not reconnect, reconnected, discovered.

8. The method of claim 1, wherein the device comprises a self-service terminal.

9. The method of claim 8, wherein self-service terminal comprises an automatic teller machine (ATM), a check-in/check-out terminal, a medical record entry terminal.

10. A device self-maintenance unit comprising a processor arranged to receive a notification that a component of a device is faulty and being further arranged to control the resetting of a respective utility associated with components of the device, cyclically to each of at least some of the components of the device.

11. The unit of claim 10, wherein the respective utility comprises power supplied to each of the at least some components of the device.

12. The unit of claim 10, wherein the respective utility comprises a communications link between each of the at least some components of the device and a core processing unit.

13. The unit of claim 12, wherein the communications link comprises a universal serial bus (USB) port.

14. The unit of claim 10, wherein, the device comprises a self-service terminal.

15. The unit of claim 14, wherein the self-service terminal comprises an automatic teller machine (ATM), a check-in/check-out terminal, a medical record entry terminal.

16. A self-service terminal comprising a device self-maintenance unit according to the claim 10.

17. Software, which when executed upon a processor, causes the processor to receive a notification that a component of a device is faulty and control the resetting of a respective utility associated with components of the device, cyclically to each of at least some of the components of the device.

18. Software according to claim 17, wherein the respective utility controlled by the processor, under the influence of the software, comprises power supplied to each of the at least some components of the device.

19. Software according to claim 17, wherein the respective utility controlled by the processor, under the influence of the software, comprises a communications link between each of the at least some components of the device and a core processing unit.

20. Software according to claim 19, wherein the communications link controlled by the processor, under the influence of the software, comprises a universal serial bus (USB) port.

21. Software according to claim 17 which, when executed on the processor, is arranged to connect to the device to the processor via a network.

22. Software according to claim 17 which, when executed on the processor, is arranged to log a disconnection event associated with the cyclical resetting of the utility of each of the at least some components of the device.

23. Software according to claim 17, which, when executed on the processor, is arranged to log a reconnection event associated with whichever of the at least some components of the device reconnect following the cyclical resetting of the utility.

24. Software according to claim 17, which, when executed on the processor, is arranged to generate a report comprising details of which of the at least some components of the device exhibited at least one of the following states following the cyclical resetting of the utility: did not reconnect, reconnected, discovered.

25. The software according to claim 17 arranged to be installed on a self-service terminal.
